(19) United States
(12) Patent Application Publication
(10) Pub. No.: US 2003/0029787 A1
(43) Pub. Date: Feb. 13, 2003

(54) Membrane with multiple, differentially permeable regions

(76) Inventors: Ying-Horng Liu, Dallas, TX (US); Kevin J. Luebke, Dallas, TX (US)

Correspondence Address: Edwin S. Flores, Esq., GARDERE WYNNE SEWELL LLP, 3000 Thanksgiving Tower, 1601 Elm Street, Dallas, TX, 75201, US

(21) Appl. No.: 09/923,177

(22) Filed: Aug. 6, 2001

(51) Int. Cl. B01D 61/00; B01D 63/08; B01D 35/00

(52) U.S. Cl. 210/416.1; 210/406; 210/473; 210/500.21

(57) ABSTRACT

The present invention includes methods for the production of a continuous differential permeable membrane and for devices that use such a membrane. One form of the present invention is a filtration apparatus having fluid permeable and fluid impermeable regions. The apparatus may be used allows for high throughout processes such as chemical synthesis and biological separations.

### TECHNICAL FIELD OF THE INVENTION

The present invention relates to continuous membranes with differential permeability regions that allow the special separation of mixtures. These membranes may have widespread use in the format of multi-well plates, each well having a continuous membrane that allows, selectively, the passage of elements in a complex mixture.

### BACKGROUND OF THE INVENTION

Microfiltration multi-well filter plates involving high-throughput, highly parallel and combinatorial methodologies are used in a variety of biological and biochemical laboratory procedures such as immune assays, nucleic acid isolation and oligonucleotide synthesis.

Typical multi-well filtration devices include a porous filter (membrane) positioned between a top plate and a bottom plate. Each well is open at the top, and is surrounded by a built-in grove that allows the wells in the top plate to align with the wells in the bottom plate such that the top plate may be stacked on top of the bottom plate. The current technology in filter plates either uses discrete filters that are individually inserted into each well, or a continuous barrier that is mechanically divided by the filter plate. These devices have a number of limitations such as being time-consuming and costly to produce, difficult to scale up in well density and unable to resist organic solvents.

Filtration devices that address the problem of cross-contamination between wells exist. For example, U.S. Pat. No. 4,948,442 describes a device having wells surrounded by ridges and grooves such that two plates (harvester tray and incubation tray) can be tightly fitted with each other. The filter paper is pushed into each well in such a way that a filter disc is cut into each well and the ridges are thermally bonded. The complexity of manufacture prevents high well density from being readily achievable in such a device. The problem of cross contamination has also been addressed in U.S. Pat. No. 5,342,581. In this filtration device, well separation is achieved by the use of gaskets that either cover all of the wells, or that are individually inserted into all wells. Again, this device does not readily allow for scale up of well density.

There is a need for an apparatus that permits high throughput filtration for, at least, biological and chemical applications while preventing cross-contamination between neighboring sample wells, and that has the ability to with stand harsh organic solvents.

### SUMMARY OF THE INVENTION

A continuous membrane containing fluid permeable and impermeable regions is described. The membrane overcomes limitations in well density in multi-well filtration plates, thus allowing for high throughput filtration processes. In filtration devices that contain this membrane, cross contamination between neighboring wells of the plate is prevented. The membrane may be comprised of, for example polypropylene or Teflon and may have a range of pore sizes. As used in this application, the term “continuous membrane” refers to a unitary material that is physically modified to create regions of permeability and regions of impermeability within the material itself, and it is not a juxtaposition of two or more separate components to produce a filtration membrane.

In one embodiment, the continuous membrane has one or more fluid permeable regions and one or more fluid impermeable regions and may be placed between two matching plates in the form of a filtration device. The top and the bottom plates have one or more holes, wells, lines or other shapes. The wells are structures that are open at each end, and have a diameter and a length. A membrane used in such a filtration device may be made of polypropylene or Teflon, and may have a range of pore sizes.

The filtration device may be modified such that the membrane and the top and the bottom plates are bound to each other. The binding of the membrane between the two plates may be achieved by glue, silicon, heat, or by a clamping mechanism. When the top plate, the bottom plate and the membrane are bound together in this fashion, a vacuum source may be attached to the bottom plate to allow for rapid removal of reagents from the wells. Again, when in this device, the membrane may be comprised of polypropylene or Teflon, and may have a range of pore sizes.

A method of production of the differentially permeable membrane includes placing the membrane under a heat source, applying heat to selective regions of the membrane and removing the membrane from the heat source. The heat source used for such a purpose may be an aluminum chuck. An aluminum chuck is a metal plate that has multiple holes, grooves, or indented regions of any shape machined into it. Alternatively, the method of production of the differential permeable membrane may include the additional step of cooling the regions of the membrane that were not exposed to the heat source during or following the heating step.

The filtration device containing the differential fluid permeable membrane sandwiched between two plates and attached to a vacuum source may be used in a variety of filtration procedures, including the separation of cellular components, the isolation of nucleic acids, the preparation of membranes for dot blotting, immunoassay procedures, oligonucleotide synthesis, peptide synthesis, combinatorial library screening, combinatorial synthesis and cell tissue culture. The differentially permeable membrane may also be used in other applications for which two or more absorbed liquids must be kept separate from each other, such as parallel assays in which a fluid permeable membrane acts as a support for absorbed analytes or reagents.

When used for oligonucleotide synthesis, a filter plate containing the differential permeable membrane may have a controlled pore glass (CPG) substrate placed in the wells. The CPG may be loaded directly into the wells, or the CPG may be encased in two sheets of polypropylene, which are sealed.

The membrane may be made differentially permeable to gases. Such membranes may be used in the production of an apparatus for tissue culture or in plant growth applications.

The membrane can also be constructed to be continuous, differentially permeable to light. A membrane containing both light permeable and impermeable regions may be used in photolithography, scintillation counting, plant growth, and in digital optical chemistry applications.

### BRIEF DESCRIPTION OF THE DRAWINGS

For a more complete understanding of the features and advantages of the present invention, reference is now made to the detailed description of the invention along with the accompanying figures. Corresponding numerals in the different figures refer to corresponding parts and in which:

FIG. 1 depicts a membrane in accordance with the present invention;

FIG. 2 depicts a multi-well filter plate in accordance with the present invention;

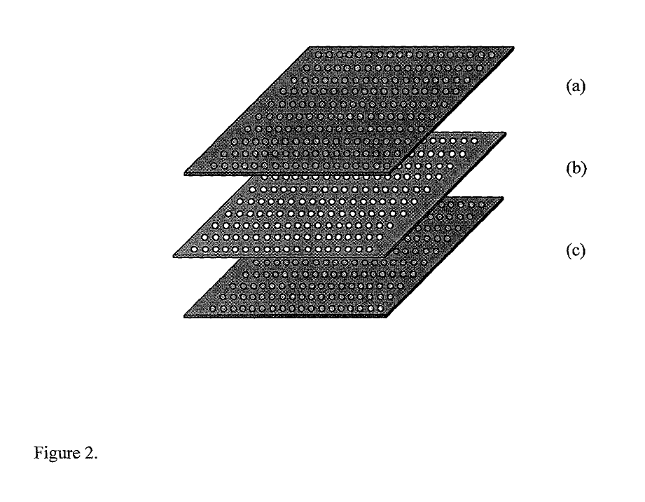

FIG. 3 depicts an aluminum heating chuck in accordance with the present invention;

FIG. 4 depicts two pieces of Delrin frame in accordance with the present invention; and

FIG. 5 depicts a 384 cooling pin rack, the unmodified membrane and the heated aluminum chuck.

FIG. 6 depicts two designs for placement of the CPG.

### DETAILED DESCRIPTION OF THE INVENTION

Although the making and using various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention, and do not delimit the scope of the invention.

Multi-well filter plates have a variety of applications in chemical and biological procedures. Currently used multi-well filtration devices are limited in well density, due in large part to the method by which such devices are assembled. In most devices, filters have to be individually inserted into each of the wells, a technically difficult and time-consuming procedure. Further, many multi-well filtration devices cannot withstand exposure to organic solvents.

The filtration device described here has several advantages. It may be scaled up to high well densities, it is cost-effective to manufacture, and there is no cross-contamination between neighboring wells. It also allows for a number of membrane types and pore sizes to be used, and it may withstand exposure to organic solvents.

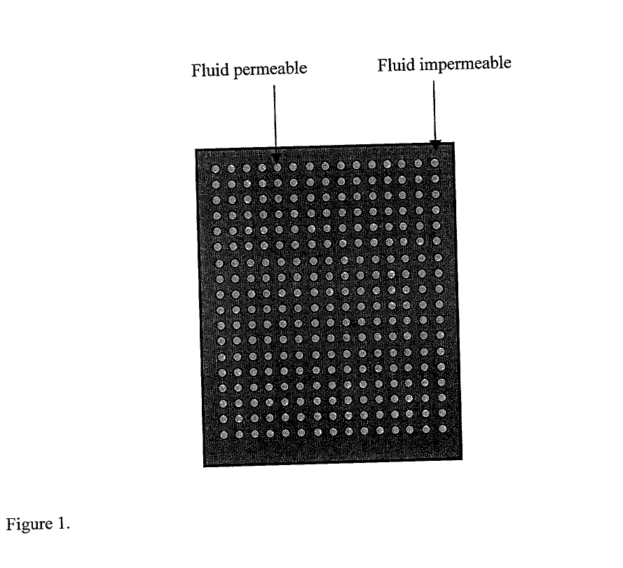

The use of a differentially permeable membrane (FIG. 1) ensures that fluids pass only pass through the wells where the fluid is introduced, thereby preventing cross contamination between neighboring wells. Fluid applied to the wells in the top plate could either pass through to the bottom plate or be differentially retained on the membrane. Thus, the device may be used for a wide range of filtration applications.

Materials

Polypropylene membranes were obtained from Millipore Corporation (Bedford, Mass.). 100% Silicon rubber sealant was obtained from Dow Corning (Baltimore, Mass.). Standard laboratory heating plates and digital thermometers were obtained from Fisher Scientific (Pittsburgh, Pa.). In one example, 384 dowel pins or points (3/32″ diameter, 1″ length) were obtained from MSC (Melville, N.Y.). An aluminum heating chuck was custom machined with 384 holes in standard 384-well plate dimensions. A two-piece Delrin plate was custom machined with 384 holes in standard 384-well plate dimensions. As will be appreciated by those of skill in the art the membrane, apparatus, system and methods of the present invention may be used to create grids, arrays and other geometries in multiple shapes and numbers. The multiple shapes and/or numbers of regions may be increased or decreased depending on the uses for which the differentially permeable regions are needed.

Membrane Fabrication

One example of membrane fabrication is the use of an metal chuck, e.g., aluminum, on the continuous membrane. A chuck is brought to, e.g., 143° C. using a heated plate. The temperature of the chuck may be monitored by inserting a digital thermometer into the heating chuck. A polypropylene membrane was placed onto the heating chuck once the desired temperature was reached. At the same time, 384 cooled pins were positioned on the opposite side of the membrane where the holes were drilled. Gentle pressure was occasionally needed to ensure full contact of the membrane and the aluminum chuck. When the heated regions of the polypropylene membrane became transparent, the chuck with the modified membrane was removed from the heat, placed onto a metal heat sink, and cooled to room temperature.

Other methods to selectively heat and/or cool regions of the continuous membrane may be used. For example, any number of heating devices or methods may be used to increase the temperature of the membrane, e.g., lasers, microwaves, radiowaves, convection, direct heat, plasma and the like. Likewise and conversely, cooling methods may include, e.g., heat sinks (whether actively or passively cooled), cooling or refrigented coils and the like.

Filter Plate Fabrication

A two-piece filter plate was assembled by applying a silicon rubber sealant to one side of each of the two plates, and the modified membrane was sandwiched between the two plates. A 24-hour waiting period was used to ensure good sealing between the two plates.

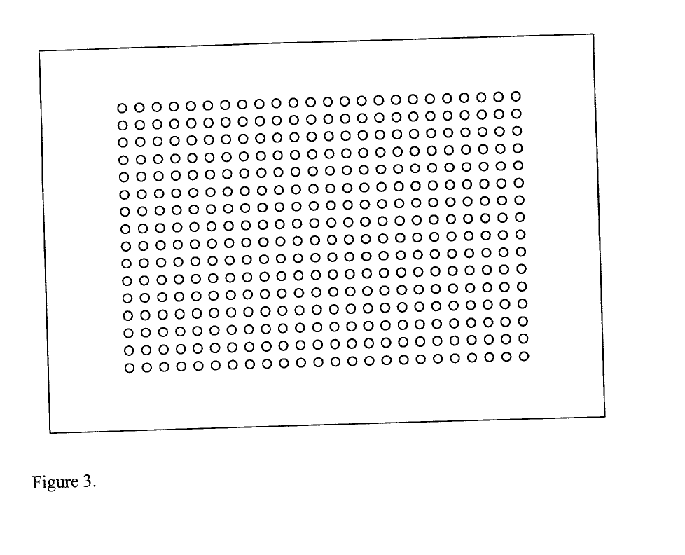

The production of the differential permeable membrane was achieved by placing a suitable, porous filter material over a heated plate (FIG. 3). The heated plate contains holes, such that which when placed in contact with the membrane, regions outside of the area of the holes heat the membrane in corresponding regions, wherein the continuous, porous material becomes sealed and effectively fluid impermeable. Regions that have not come into contact with the heat will be fluid permeable. When used in the form of a multi-well filtration device, the fluid permeable regions and impermeable regions of the membrane correspond to the wells of the plate, and the regions surrounding the wells, respectively.

Polypropylene was selected as a membrane due to its chemical compatibility, available pore sizes and low melting temperature (160° C.). The plate was heated to various temperatures and different membranes were placed on the chuck for varying lengths of time. The heating chuck used had 384-well plates drilled throughout, creating 384 well circles that were fluid permeable. The rest of the areas were fluid impermeable. At 145° C., the membrane changed from its original color (white) to clear. The optimal time for this transition was approximately three seconds when gentle pressure was applied to ensure full physical contact. Long heating times caused burning of the polypropylene. When the heating time was insufficient, insufficient melting occurred and liquid wicked through the impermeable regions.

The modified polypropylene was found to shrink in dimensions. The closure of the pores physically changed the structure of the membrane, and shrinking likely occurred when the plastic was cooled down and peeled from the heating chuck. The cooling speed was changed and methods such as placing the entire chuck in an ice bath, cooling rapidly by acetonitrile mist, and cooling the membrane gradually at room temperature were tried. Cooling and removing the membrane in room temperature resulted in the least amount of shrinkage.

In addition to polypropylene, a variety of porous materials including Teflon may be used. The term “microporous membrane” means a membrane, that is of a matrix of interconnected material, in which the material defines a sponge-like structure having interconnected flow channels of width defined within limits (i.e., pore size). The membrane used may have range of pore sizes, depending on the particular application envisioned for the filtration device.

With regard to membrane type, Teflon exhibits much better chemical compatibility compared with polypropylene. Porous Teflon membrane from Pall Gelman was tested (0.45 μM) using the same method as described above for polypropylene. Teflon's melting point, however, is harder to reach (329° C.) and the membrane experienced more curling once heat was applied.

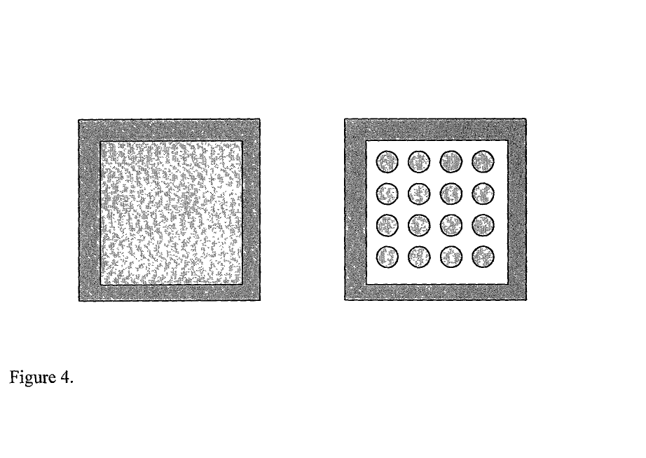

The effect of the heating process on the permeability of the modified and unmodified membrane was measured. The effect was measured by machining four pieces of Delrin with the same area of holes in the middle and sandwiching the modified and unmodified portions of the membrane with two mini filter plates (FIG. 4). A fixed volume (approximately 1 ml) of a common synthesis solvent, acetonitrile, was deposited into the plate and the time was measured to see how long it would take for gravity to pull out all of the acetonitrile (Table 1).

TABLE 1
The flow rate of the modified (Type B) and
the unmodified (Type A) membrane.

| Type A | Type B |
|---|---|
| Area: 3.06 cm² | Area: 1.95 cm² |
| 51.6 second/cm² | 108.2 second/cm² |
| 50.9 second/cm² | 109.2 second/cm² |
| 51.6 second/cm² | 110.3 second/cm² |
| 52.2 second/cm² | 105.1 second/cm² |
| Average: 51.6 second/cm² | Average: 108.2 second/cm² |

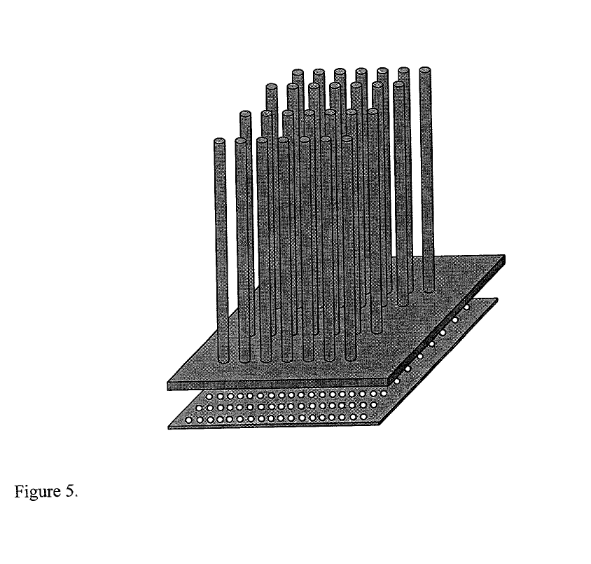

The results show that since the flow rate in a given area of the heated membrane is consistently lower than the unheated membrane, the nominally unmodified regions of heated membrane must have been affected and there is a decrease in pore size. The decrease in pore size may be circumvented by positioning 384 cooling pins directly onto the regions that are not intended to be heated (FIG. 5). Using the cooled pins allows the temperature of the contacted regions to stay relatively cool, and prevent pores from closing.

The filter plate is assembled by depositing silicon sealant on one side of the filter plate and sandwiching the modified membrane between two plates. The top and bottom Delrin plates have dimensions that match the aluminum heating chuck. Other methods of sealing such as heat and glue may also be used for specific needs. Silicon was chosen due to its chemical characteristics and ease of deposition. Care must be taken to deposit only a thin layer of sealant in order to prevent undesirable sealing of reaction wells. To ensure the deposition of a thin layer of silicon, each of the 384 wells were plugged with matching pins. Smearing sealant onto the plugged surface, and removing the pins carefully resulted in a perfect layer of sealant without silicon in the wells.

When the multi-well filtration device is fused in this way, a vacuum source may be attached through an outlet in the bottom plate to allow for rapid filtration through the modified membrane.

The successfully sealed filter plate includes the differential continuous membrane between the two fused Delrin plates was tested by deblock solution (3% trichloroacetic acid in dichloromethane), a solvent typically used in DNA synthesis, mixed with a dye in selective wells. Through 10 cycles of deposition and vacuum fluid removal, no cross contamination was observed between the wells and the membrane's structure was intact.

The invention disclosed in this document may be envisioned to be useful in a variety of chemical and biotechnological capacities where increase the number of processes done in parallel is important. The multi-well filter plate is particularly suitable for processes such as oligonucleotide synthesis that involve multiple addition rounds and deblocking cycles.

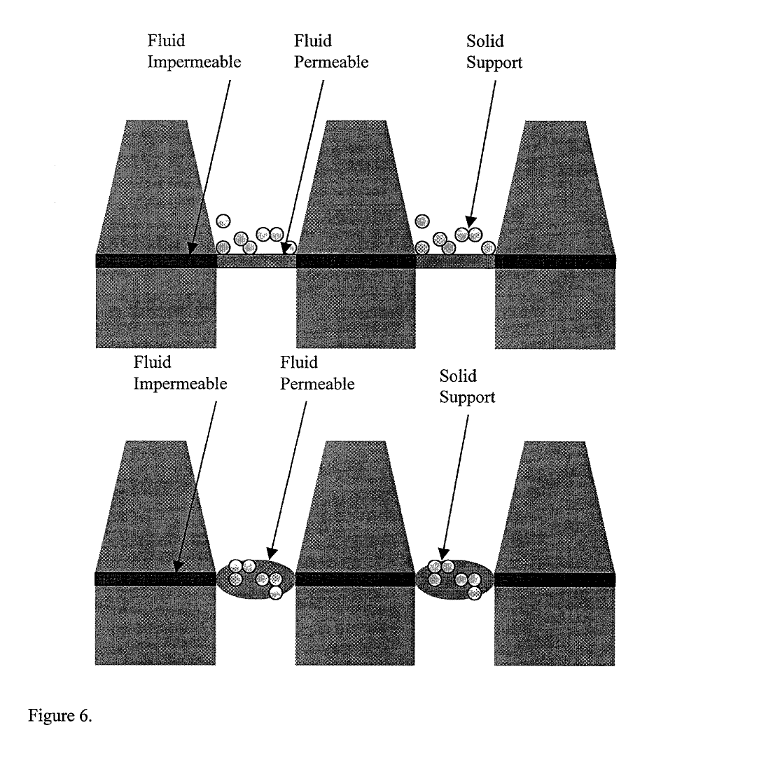

For oligonucleotide synthesis, a solid support, typically controlled pore glass (CPG) is used to attach substrate to the wells of the plate. The CPG may be placed directly into each well, or may be encased in two layers of polypropylene. The polypropylene layers may then be sealed by heating a desired region (FIG. 6). This new design prevents manual CPG loading into each well, and the plate may be pre-manufactured and delivered to customers.

Membrane material that may withstand multiple exposures to harsh organic reagents was tested using the invention. Rapid, high throughput synthesis is possible in such a device as well density may be increased in comparison to multi-well filter devices that are limited in well density. Membranes to be used for large-scale nucleic acid hybridization studies such as dot blotting may be prepared using the invention. Cellular components such as nucleic acids and small proteins may be separated by passage through the filter plate and purified by progressive washing of the membrane.

Alternatively, components retained on the filter plate may be quantified by immunoassays, such as those commonly used for quantification of hormones or receptor binding. The device may be used to develop diagnostic tests, such as testing for the presence of various enzymes or small molecules. Procedures such as combinatorial library screening may also be carried out using the invention. Combinatorial synthesis and peptide synthesis may also be carried out. Any applications in which two or more absorbed liquids must be kept separate from each other may be accomplished wherein the fluid permeable membrane acts as a support for absorbed analytes or reagents.

The differential permeability of the membrane of the present invention is not limited to fluids. The membrane may be made to be differentially permeable to gas or to light. A membrane modified in such a way that it becomes differentially permeable to gases has applications in plant growth. Plant growth is dependent upon carbon dioxide concentrations in the ambient environment. Further, oxygen supply is critical to the survival cells in tissue culture. A membrane with differentially gas permeable regions may be used to supply oxygen needed for the growth of tissue culture cells while minimizing the diffusion of contaminants into the plate.

Many potential applications for differentially light permeable membranes exist and are encompassed by the present invention. For example, in scintillation counting involving multiple small volume measurements, a differential light permeable membrane in a filter plate would be advantageous. Regions that are light permeable would correspond to the wells, and the impermeable regions would correspond to regions between the wells. Various applications may be envisioned by those of skill in the art in light of the present disclosure in which differentially light permeable membrane may be used to control the rates of photochemical reaction.

The area of photolithography may also benefit from a light permeable membrane. Photolithography is a process for manufacturing a semiconductor device in which a projection exposure apparatus is used. For example, the pattern of a photomask or a reticle is transferred via a projection optical system to a semiconductor wafer coated with a photosensitive material. In such an apparatus, a shutter device is used to open and close the path of light from a light source. A membrane that is differentially permeable to light for use as a mask may serve as an alternative to the shutter device.

A differentially light permeable membrane may also be useful in chemiluminescent studies wherein calorimetric changes are detected. A filtration plate containing such a membrane may be incorporated into equipment that can be automated to record, analyze and manipulate data.

The methods and compositions of the present invention are described and disclosed it is to be understood that this invention is not limited to the particular methods and compositions described as such may, of course, vary. It is also to be understood that the terminology used herein is for the purpose of describing particular embodiments only, and is not intended to be limiting since the scope of the present invention will be limited only by the appended claims.

While this invention has been described in reference to illustrative embodiments, this description is not to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A membrane comprising:
one or more fluid permeable regions and one or more fluid impermeable regions in a continuous membrane.

2. The membrane recited in claim 1 wherein the membrane comprises microporous material.

3. The membrane recited in claim 1 wherein the membrane comprises polypropylene.

4. The membrane recited in claim 1 wherein the membrane comprises polypropylene having a pore size between 0.1 and 100 μM.

5. The membrane recited in claim 1 wherein the membrane comprises Teflon.

6. The membrane recited in claim 1 wherein the membrane comprises Teflon having a pore size between 0.1 and 100 μM.

7. An apparatus comprising:
a membrane comprising one or more fluid permeable and one or more fluid impermeable regions; and
a plate having one or more wells;
wherein the membrane positioned on the plate.

8. The apparatus recited in claim 7 further comprising an outlet for attachment of a vacuum to the plate.

9. The apparatus recited in claim 7 wherein the membrane comprises polypropylene.

10. The apparatus recited in claim 7 wherein the membrane comprises polypropylene having pore size between 0.1 and 100 μM.

11. The apparatus recited in claim 7 wherein the membrane comprises Teflon.

12. The apparatus recited in claim 7 wherein the membrane comprises Teflon having pore size between 0.1 and 100 μM.

13. A filtration system comprising:
a membrane comprising one or more fluid permeable and one or more fluid impermeable regions;
a top plate having one or more wells;
a second plate having one or more wells; and
wherein the membrane is between the top plate and the bottom plate.

14. The membrane recited in claim 13 wherein the membrane comprises microporous material.

15. The filtration system recited in claim 13 wherein the membrane comprises polypropylene.

16. The filtration system recited in claim 13 wherein the membrane comprises polypropylene having a pore size between 0.1 and 100 μM.

17. The filtration system recited in claim 13 wherein the membrane comprises Teflon.

18. The filtration system recited in claim 13 wherein the membrane comprises Teflon having pore size between 0.1 and 0.45 μM.

19. An apparatus comprising:
a membrane comprising one or more fluid permeable and one or more fluid impermeable regions;
a top plate having one or more wells;
a second plate having one or more wells; and
wherein the membrane positioned between the top plate and bottom plate such that the membrane, the top plate and the bottom plate are bound to each other.

20. The apparatus recited in claim 19 further comprising an outlet for attachment of a vacuum to the bottom plate.

21. The apparatus recited in claim 19 wherein the top plate, the bottom plate and the membrane are bound to each other by heating the plates.

22. The apparatus recited in claim 19 wherein the top plate, the bottom plate and the membrane are bound to each other by glue.

23. The apparatus recited in claim 19 wherein the top plate, the bottom plate and the membrane are bound to each other using pressure.

24. The membrane recited in claim 19 wherein the membrane comprises microporous material.

25. The apparatus recited in claim 19 wherein the membrane comprises polypropylene.

26. The apparatus recited in claim 19 wherein the membrane comprises polypropylene having pore size between 0.1 and 100 μM.

27. The apparatus recited in claim 19 wherein the membrane comprises Teflon.

28. The apparatus recited in claim 19 wherein the membrane comprises Teflon having pore size between 0.1 and 100 μM.

29. A method for preparing a differential permeable membrane comprising the steps of:
placing the membrane between two plates; and
clogging the pores of selective regions of the membrane.

30. The method recited in claim 29 wherein the clogging is accomplished by a non-permeable substance.

31. The method recited in claim 29 wherein the clogging is accomplished by sealing with heating.

32. The method recited in claim 29 wherein the clogging is accomplished by permeating with a fluid material that becomes non-fluid after infusion into the membrane.

33. The method recited in claim 29 wherein the clogging is accomplished by sealing with caulk.

34. The method recited in claim 29 wherein the clogging is accomplished by silicon.

35. The membrane recited in claim 29 wherein the membrane comprises microporous material.

36. The method recited in claim 29 wherein the membrane comprises polypropylene.

37. The method recited in claim 29 wherein the membrane comprises polypropylene having pore size between 0.1 and 100 μM.

38. The method recited in claim 29 wherein the membrane comprises Teflon.

39. The method recited in claim 29 wherein the membrane comprises Teflon having pore size between 0.1 and 100 μM.

40. The method recited in claim 29 wherein the prepared membrane is used in the construction of a filtration device comprising:
the membrane comprising one or more fluid permeable and impermeable regions;
a top plate containing wells;
a bottom plate containing wells; and
wherein the membrane is placed between the top and bottom plates, and all three are bound together.

41. The method recited in claim 29 wherein the membrane is used in separation of cellular components.

42. The method recited in claim 29 wherein the membrane is used for isolation of nucleic acids.

43. The method recited in claim 29 wherein the membrane is used in assays for determination of protein binding.

44. The method recited in claim 29 wherein the membrane is used in the preparation for dot blotting.

45. The method recited in claim 29 wherein the membrane is used in immunoassays procedures.

46. The method recited in claim 29 wherein the membrane is used for oligonucleotide synthesis.

47. The method recited in claim 46 wherein a CPG substrate is placed in each well.

48. The method recited in claim 46 wherein a CPG substrate is encased in polypropylene.

49. The method recited in claim 29 wherein the membrane is used in combinatorial library screening.

50. The method recited in claim 29 wherein the membrane is used for combinatorial synthesis.

51. The method recited in claim 29 wherein the membrane is used in enzyme assays.

52. The method recited in claim 29 wherein the membrane is used in assays wherein the fluid permeable membrane acts as a support for absorbed reagents.

53. The method recited in claim 29 wherein the membrane is used for tissue culture.

54. The method recited in claim 29 wherein the membrane is used for cell culture.

55. The method recited in claim 29 wherein the membrane is used in peptide synthesis.

56. A method for preparing a membrane comprising one or more fluid permeable and one or more fluid impermeable regions comprising the steps of:
placing the membrane on a heat source;
heating selective portions of the membrane; and
removing the membrane from the heat source.

57. The method recited in claim 56 wherein the heat is applied in such a way that the temperature is above 140° C.

58. The method recited in claim 56 wherein the heat source is an aluminum chuck comprising one or more indentations.

59. The method recited in claim 58 wherein the indentations comprise a shape selected from a circle, a square, a triangle, a rectangle, a hexagon, an octagon, an ellipse, a pentagon, a decagon, a hexagon, a heptagon, a geometrical shape, a line and a ridged structure.

60. The method recited in claim 56 wherein the heat source comprises a block comprising one or more indentations.

61. The method recited in claim 60 wherein the indentations comprise a shape selected from a circle, a square, a triangle, a rectangle, a hexagon, an octagon, an ellipse, a pentagon, a decagon, a hexagon, a heptagon, a geometrical shape, a line and a ridged structure.

62. The membrane recited in claim 56 wherein the membrane comprises microporous material.

63. The method recited in claim 56 wherein the membrane comprises polypropylene.

64. The method recited in claim 56 wherein the membrane comprises polypropylene having pore size between 0.1 and 100 μM.

65. The method recited in claim 56 wherein the membrane comprises Teflon.

66. The method recited in claim 56 wherein the membrane comprises Teflon having pore size between 0.1 and 100 μM.

67. The method recited in claim 56 wherein the prepared membrane is used in the construction of a filtration device comprising:
the membrane comprising one or more fluid permeable and impermeable regions;
a top plate containing wells;
a bottom plate containing wells; and
wherein the membrane is placed between the top and bottom plates, and all three are bound together.

68. The method recited in claim 56 wherein the membrane is used in separation of cellular components.

69. The method recited in claim 56 wherein the membrane is used for isolation of nucleic acids.

70. The method recited in claim 56 wherein the membrane is used in assays for determination of protein binding.

71. The method recited in claim 56 wherein the membrane is used in the preparation for dot blotting.

72. The method recited in claim 56 wherein the membrane is used in immunoassay procedures.

73. The method recited in claim 56 wherein the membrane is used for oligonucleotide synthesis.

74. The method recited in claim 73 wherein a CPG substrate is placed in each well.

75. The method recited in claim 73 wherein a CPG substrate is encased in polypropylene.

76. The method recited in claim 56 wherein the membrane is used in combinatorial library screening.

77. The method recited in claim 56 wherein the membrane is used for combinatorial synthesis.

78. The method recited in claim 56 wherein the membrane is used in enzyme assays.

79. The method recited in claim 56 wherein the membrane is used in assays wherein the fluid permeable membrane acts as a support for absorbed reagents.

80. The method recited in claim 56 wherein the membrane is used for tissue culture.

81. The method recited in claim 56 wherein the membrane is used for cell culture.

82. The method recited in claim 56 wherein the membrane is used in peptide synthesis.

83. A method for preparing a membrane comprising one or more fluid permeable and one or more fluid impermeable regions comprising:
placing the membrane on a heat source;
heating selective portions of the membrane;
cooling those regions of the membrane to which no heat is applied; and
removing the membrane from the cooling source.

84. The method recited in claim 83 wherein the cooling is accomplished through the use of metal pins.

85. The method recited in claim 83 wherein the heat is applied in such a way that the temperature is above 140° C.

86. The method recited in claim 83 wherein the heat source is an aluminum chuck comprising one or more indentations.

87. The method recited in claim 86 wherein the indentations comprise a shape selected from a circle, a square, a triangle, a rectangle, a hexagon, an octagon, an ellipse, a pentagon, a decagon, a hexagon, a heptagon, a geometrical shape, a line and a ridged structure.

88. The method recited in claim 83 wherein the heat source comprises a block comprising one or more indentations.

89. The method recited in claim 88 wherein the indentations comprise a shape selected from a circle, a square, a triangle, a rectangle, a hexagon, an octagon, an ellipse, a pentagon, a decagon, a hexagon, a heptagon, a geometrical shape, a line and a ridged structure.

90. The membrane recited in claim 83 wherein the membrane comprises microporous material.

91. The method recited in claim 83 wherein the membrane comprises polypropylene.

92. The method recited in claim 83 wherein the membrane comprises polypropylene having pore size between 0.1 and 100 μM.

93. The method recited in claim 83 wherein the membrane comprises Teflon.

94. The method recited in claim 83 wherein the membrane comprises Teflon having pore size between 0.1 and 100 μM.

95. The method recited in claim 83 wherein the prepared membrane is used in the construction of a filtration device comprising:
the membrane comprising one or more fluid permeable and impermeable regions;
a top plate containing wells; and
a bottom plate containing wells;
wherein the membrane is placed between the top and bottom plates, and all three are bound together.

96. The method recited in claim 83 wherein the membrane is used in separation of cellular components.

97. The method recited in claim 83 wherein the membrane is used for isolation of nucleic acids.

98. The method recited in claim 83 wherein the membrane is used in assays for determination of protein binding.

99. The method recited in claim 83 wherein the membrane is used in the preparation for dot blotting.

100. The method recited in claim 83 wherein the membrane is used in immunoassay procedures.

101. The method recited in claim 83 wherein the membrane is used for oligonucleotide synthesis.

102. The method recited in claim 101 wherein a CPG substrate is placed in each well.

103. The method recited in claim 101 wherein a CPG substrate is encased in polypropylene.

104. The method recited in claim 83 wherein the membrane is used in combinatorial library screening.

105. The method recited in claim 83 wherein the membrane is used for combinatorial synthesis.

106. The method recited in claim 83 wherein the membrane is used in enzyme assays.

107. The method recited in claim 83 wherein the membrane is used in assays wherein the fluid permeable membrane acts as a support for absorbed reagents.

108. The method recited in claim 83 wherein the membrane is used for cell culture.

109. The method recited in claim 83 wherein the membrane is used for tissue culture.

110. The method recited in claim 83 wherein the membrane is used in peptide synthesis.

111. A membrane comprising:
one or more gas permeable regions and one or more gas impermeable regions.

112. The membrane recited in claim 111 wherein the membrane comprises microporous material.

113. An apparatus comprising:
a membrane comprising one or more gas permeable regions and one or more gas impermeable regions;
a top plate having one or more chambers; and
a bottom plate;
wherein the membrane is between the top and the bottom plate.

114. The apparatus recited in claim 113 wherein the apparatus is used in tissue culture.

115. The apparatus recited in claim 113 wherein the apparatus is used in controlling the growth of microorganisms.

116. An apparatus comprising:
a membrane with one or more gas permeable regions and one or more gas impermeable regions;
an outer covering having one or more holes; and
an inner covering;
wherein the membrane is placed between the inner and outer covering.

117. The apparatus recited in claim 116 further comprising a gage to control entry of gases.

118. The apparatus recited in claim 116 further comprising an outlet that controls exit of gases.

119. The apparatus recited in claim 116 wherein the apparatus is used in plant growth chambers.

120. A membrane comprising one or more light permeable regions and one or more light impermeable regions.

121. The membrane recited in claim 120 wherein the membrane comprises microporous material.

122. The membrane recited in claim 120 wherein the membrane is used as a mask in photolithography.

123. The membrane recited in claim 120 wherein the membrane is used to control the rate of one or more photochemical reactions.

124. The membrane recited in claim 120 wherein the membrane is used in plant growth.

125. The membrane recited in claim 120 wherein the membrane is used in microbial growth.

126. An apparatus comprising:
a membrane with one or more light permeable regions and one or more light impermeable regions;
a top plate having one or more chambers; and
a bottom plate;
wherein the membrane is between the top and bottom plates.

127. The apparatus recited in claim 126 wherein the apparatus is used in scintillation counting.

128. The apparatus recited in claim 126 wherein the apparatus is used in chemiluminescent applications.

129. The membrane recited in claim 126 wherein the membrane is used in plant growth.

130. The membrane recited in claim 126 wherein the membrane is used in microbial growth.
